(19) United States
(12) Patent Application Publication
(10) Pub. No.: US 2002/0005255 A1
(43) Pub. Date: Jan. 17, 2002

(54) One piece device

(76) Inventor: Paulo Leonardi, Camerano (IT)

Correspondence Address: Allen D. Brufsky, P.A., 10700 Stringfellow Road, Unit 80, Bokeelia, FL, 33922, US

(21) Appl. No.: 09/924,332

(22) Filed: Aug. 7, 2001

Related U.S. Application Data
(60) Provisional application No. 60/218,155, filed on Jul. 14, 2000.

(51) Int. Cl. B32B 1/00

(52) U.S. Cl. 156/391

(57) ABSTRACT

The invention relates to a device for placing a label with a first central opening on a compact disc with a second central opening, and to a method for the use of the device as well as a method for manufacturing the device. The device has a positioning member 5 having at least one centering member 7. The external dimension of the centering member 7 corresponds to the first central opening of the label. Moreover the positioning member has a centering part 8 in its center, the outer diameter of which corresponds to the second central opening of the compact disc. The centering part 8 projects beyond the centering member 7. A base member 9 has an outer ring supporting a disc-shaped top surface on which the label can be positioned. The top surface has a central opening within which the positioning member is arranged moveably perpendicular to the top surface, and in an inoperative position projects beyond the top surface and in a labeling position is lowered into the central opening. For the reset into the starting position, the outer ring has at least one flexible tongue in a first adapted groove in the outer ring. The tongue roots of the flexible tongue are fixed at the base section of the outer ring while the tongue tips support a flexible supporting beam. The supporting beam extends radially inwardly from the tongue tips in a second adapted groove of the top surface to the positioning member.

This application claims priority of provisional application, Ser. No. 60/218,155, filed Nov. 13, 2000 entitled, “One Piece CD Applicator,” in the name of the same inventor and assignee.

Device for placing a label onto a compact disc as well as method for manufacturing and the use of the device.

The invention relates to a device and a method for placing a label onto a compact disc according to the pre-characterizing portion of claim 1 and to a method for manufacturing the device as well as a method for the use of the device.

From document DE 295 21 938 U1, a device for the positioning of self-adhesive labels on compact discs is known. This device comprises several single components which can be plugged into each other coaxially, and thereby centrally position a label on top of a compact disc in a centered and aligned manner.

This device has the disadvantage that single components have to be produced which have to be worked differently which have to be nested into each other fittingly. Moreover, the device has the disadvantage that it neither has a stable inoperative position nor a stable labeling position, but rather both positions have to be met by the user himself manually, without any adequate stoppers or other devices being available for the user during alignment and matching of the label on the compact disc.

Due to the increasing distribution of compact discs which are also known as laser discs and which are distributed in form of music and compact disc ROM-products, there is the necessity, to facilitate the handling of labeling devices, and to ensure a reliable centered applying of labels onto compact discs, particularly since the popularity of recordable compact discs, e.g. from Sony, 3M, and Kodak, has increased in the recent years. With this variety of applications, the necessity has increased to mark and to label compact discs as soon as they are produced. Labels on compact discs are required, because there is no visual method to determine the contents of the manufactured discs which can contain more than 680 MB of data. While manufacturers of large quantities of identical compact discs with prefabricated and already applied blank discs or directly on the backside of the discs can draw, paint or in any other manner, with a layer of ink and pigments can apply their own identification information, this method cannot be carried out by manufacturers of recordable compact discs, because the user himself decides what is to be stored on a compact disc. With respect to a low number of copies and copies where an immediate availability of the compact discs is required, printing and drawing of labels takes too much time; and requires high costs of investment for the specific equipment.

A further embodiment of a labeling device is known from document WO 98/26986. This device comprises a basic member, which is surrounded by an outer ring, which has, in its center, a fixed centering rod, whereby the diameter of the centering rod corresponds to the central opening of the compact disc. On this base member, a disc is fixed with blade springs extending radially inwardly. The blade springs are clamped on one side at the edge of the disc and carry centering members aligned vertically on their free end for centering a label end and for supporting a compact disc which is to be put on the centering rod. Thereby, the compact disc is supported in a distance to the label by the elastically supported centering members, and for labeling, the compact disc can be pushed onto the label. Thereby, there is the risk that the label is displaced, because the centering members can be displaced with respect to each other during the lowering of the compact disc, and thus, reduce the centering diameter can decrease.

The disadvantage of reducing the centering diameter can be compensated by precisely dimensioned projections at the tips of the centering members, however, these projections can only become effective when the compact disc is placed completely plane-parallel with respect to the label. This, however, has a relevant additional disadvantage, because, with respect to the handling of this labeling device, it can not be presupposed that the user carries out a plane-parallel guidance of the compact disc being devoid of any support with respect to the label being arranged in a distance thereto. Already due to a slight tilting of the compact disc, the label will be connected or glued at an outer point which does not correspond to the center of the compact disc, and a damage of the inner edge of the label will result from the projections fixed to the centering members on the opposing inner edge of the conglutination between compact disc and label which resulted from tilting.

In case, the centering projections are omitted to avoid damage of the labels by the projections during tilting of the compact disc, the risk exists that the label will be stuck on the compact disc totally eccentrical, because during lowering of the compact discs the centering diameter of the centering members is reduced, and therefore, the position of the label cannot be ensured. When sticking an eccentrical label onto a compact disc, at the high rotating speeds of the compact disc, a balance error will occur in the reproducing system such that it can stress or even damage the drive assembly of the reproducing system.

It is an object of the invention to provide a device for placing a label with a central opening on a compact disc which overcomes the disadvantages of prior art, and ensures an improved guidance of the label with respect to the compact disc during preparation and carrying out of the labeling procedure. Further, it is an object of the invention to provide a labeling device which can be produced at low costs and, therefore, provides a simplified cost-effective assembly.

The object is solved by the subject-matter of the independent claims. Preferred embodiments of the invention are defined in the dependent claims.

Preferably, the device for placing a label with a central opening onto a compact disc with a smaller central opening has the following components:

1. a positioning member having at least one centering member, the external dimension of which is adapted to the central opening of the label and which has a centering member in its center—preferably a centering rod—the external diameter of which is adapted to the central opening of a compact disc, which protrudes beyond the centering member,

2. a basic member with an outer ring having a disc-shaped top surface on which the label can be positioned whereby the top surface has a central opening within which the positioning member is moveably arranged perpendicular to the top surface, and, in an inoperative position, projects beyond the top surface, and in a labeling position, is lowered into the central opening,

3. at least one flexible tongue which is arranged in a first adapted groove of the outer ring whereby the tongue root of the flexible tongue is fixed to the base section of the outer ring, and the flexible tongue supports a flexible supporting beam,

4. whereby the supporting beam extends from the tongue tips radially inwardly into a second adapted groove of the disc-shaped top surface up to the positioning member.

This device has the advantage that the positioning member which is capable of supporting a compact disc on its centering members, forms a compact unit with the at least one centering member and the centering rod so that during transition from the inoperative position of the positioning member to the labeling position of the positioning member, neither the label which rests on the disc-shaped top surface of the outer ring, nor the compact disc which is supported by the centering rod and the centering members in central alignment with respect to the label, can be displaced with respect to each other, even if the user should tilt the compact disc slightly during placing.

By means of the stable and rigid arrangement of the positioning member and the centering members fixed thereto firmly as well as the centering rod connected thereto fixedly, neither the centering diameter for the label nor the centering diameter for the compact disc do change during the transition from a inoperative position to the labeling position. Further, the compact disc is supported in a completely stable position because no relative movements between the centering rod and the central opening of the compact disc are required during the labeling process so that the risk of tilting the compact disc is not given.

In a preferred embodiment of the invention, the cross-section of the flexible tongues is concave-curved, and each flexible tongue has a pressure point. This is achieved in an advantageous manner when the flexible tongues are parts of the outer ring, and are formed by cutting the outer ring. Thereby, a concave cross-section of the flexible tongues results, the curvature of which corresponds to the curvature of the outer ring. During lowering of the positioning member from the inoperative position into the labeling position, a pressure point has to be overcome by the power transmission of the supporting beams to overcome the form drag of the concave cross-section of the flexible tongues, and to pass into the labeling position. This, at the same time, has the advantage that a substantially intensified restoring force is effected for the snapping back into the inoperative position by means of the flexible tongues. This pressure point additionally facilitates a handling of the device because the positioning member takes a very stable position during the placing of the compact disc which only upon overcoming the pressure point of the concave-curved spring, releases the positioning member to carry out the labeling process.

In a further embodiment of the invention the positioning member forms a one-piece unit with the centering member and centering rod which is dimensionally stable and resilient without being deformed during the transition from the inoperative position to the labeling position.

In a further preferred embodiment of the invention, the centering member and the centering rod are movable together and simultaneously perpendicular to the disc-shaped top surface. Such a function cannot be carried out with the subject-matter known from WO 98/26986, because the centering rod, in the known embodiment, is mounted fixedly on the base member, and, therefore, the compact disc has to be guided with its central opening on the centering rod with the risk of tilting, which is improved by the present invention because according to the present invention, there is no relative movement between compact disc/centering rod during the labeling process nor has this to be carried out by the user.

A further embodiment of the invention provides for the centering member, the centering rod, the flexible supporting beams, the flexible tongues, and the outer ring, to be connected to each other none-releasably. This is achieved by the one-piece form of the device. Consequently, in contrast to prior art, several complex parts for forming the device do not have to be connected or fitted together, but rather all functional parts of the present invention form a one-piece component which preferably is formed as a one-piece injection-molded part.

To realize a one-piece injection molded part which is fabricable in a most simple manner in a two-part injection mould, the walls can be formed slightly tapered to ensure detachment from the injection mould. These tapered walls improve also the functionality of the labeling device because the centering rod is not formed totally cylindrical but rather is tapered towards its tip which facilitates an application of the compact disc. The same applies for the centering members which facilitates the setting and placing of the label by means of their tapered walls. The taper, in an advantageous manner, can be provided in an angle between 0.5 and 5 degrees.

In a further preferred embodiment of the invention, the positioning member has a ring-shaped base as centering member, on the surface of which in its center the centering rod protrudes. Such a positioning member has the advantage that the ring-shaped base which serves for the centering of the label, is extremely dimensionally stable, and can form a plane surface, on which a compact disc can be centered by means of the centering rod projecting in its center. The ring-shaped base provides for the vertical pressure to be transmitted onto the positioning member by the user through the supporting beams to the flexible tongues arranged in the outer ring during transition from the inoperative position to the labeling position, without a change of the dimension of the ring-shaped base and the centering rod so that the positions of the label with respect to the compact disc remain unchanged with respect to each other during the transition from the inoperative position to the labeling position.

In a further embodiment of the invention the centering member can be provided as a ring which has a base plate in the center of which a centering rod is arranged. Such a centering ring with a base plate has the advantage that a reliable translation of the pressure force into a tensile force through the supporting beams to the tongue tips during the transition from the inoperative position to the labeling position will be achieved without a deformation of the centering member.

In a further preferred embodiment of the invention it is provided for the centering member to have at least two segments of a circle which project beyond the top surface of the outer ring, and are connected to each other via a circular base plate. This construction corresponds to the construction of a ring-shaped centering member, however, the ring is not realized completely but is rather provided as segments of a circle which are arranged on a circular base plate whereby the circular base plate itself takes up the tensile forces which occur during the transition from the inoperative position to the labeling position.

In a further embodiment of the invention it is provided for the supporting beams to be tapered radially inwards towards the positioning member. Due to this, the flexibility of the supporting beam has been increased in an advantageous manner so that the supporting beams effect only a slight resistance during transition from the inoperative position into the labeling position, and only apply a low deformation force on the centering members.

In a further embodiment of the invention it is provided for the flexible tongues to be broader in the root section of the tongues than in the tip section of the tongues. According to this embodiment the tongue tips are stressed stronger than the root section of the tongues so that the base section of the outer ring is less stressed and, therefore the risk of the formation of fissures in the base section of the outer ring is reduced.

In a further embodiment of the invention the outer ring is enforced in the base section. This can be achieved by a bead-shaped reinforcement. Such a reinforcement serves for the dimensional stability of the outer ring and reduces the risk of the formation of fissures in the tongue root section of the flexible tongues at the outer ring. In a further embodiment of the invention the outer ring has an outer flange in the base section. This outer flange serves for the purpose, e.g., to fix the device onto a mounting table to provide for an unchangeable working position. At the same time, the outer flange reinforces the base section of the outer ring so that a risk of formation of fissures in the riot section of the flexible tongues is reduced.

In a further preferred embodiment of the invention, at least three flexible tongues with three flexible supporting beams are arranged at the circumference of the outer ring. Three or more flexible tongues with the corresponding flexible supporting beams increase the directional stability of the positioning member during the transition from the inoperative position into the labeling position. Simultaneously, however, they reduce the supporting surface for the label on the disc-shaped top surface of the outer ring.

A further embodiment of the invention provides for a compensation disc to be arranged on the disc-shaped top surface of the outer ring having a central opening through which the positioning member is freely movable, and which supports the label. This compensation disc can be a component which is detachable from the device so that it is replaceable at any time in case the disc-shaped surface of the compact disc is damaged by glue residuals or other remainders of application. This device also has the advantage that the working surface of the disc-shaped top surface of the outer ring is renewable at any time without the complete device having to be replaced.

A method for the use of the device for labeling a compact disc preferably comprises the following procedure steps:

1. placing the label with non-adhesive side downwards onto the horizontal disc-shaped top surface of the basic member whereby the adhesive side of the label points upwards, and the label is pushed with its central opening over the centering member,

2. detaching of a lamination sheet from the adhesive side of the label,

3. placing the compact disc with its labeling side downwards onto the positioning member whereby the compact disc is pushed with its central opening over the centering rod, and is resting on the centering element, and whereby the distance between label and compact disc is determined by the height of the centering member projecting beyond the disc-shaped top surface in the inoperative position,

4. pushing down the positioning member with the compact disc resting on the centering member from the inoperative position in vertical direction into the labeling position on the adhesive side of the label,

5. relieving the positioning member whereby the positioning member by means of the flexible tongues at the outer ring bounces back into the inoperative position, and thereby raises the labeled compact disc resting on a centering member from the top side of the base member.

This method for labeling a compact disc by using the device according to the invention has the advantage that a reliable central positioning of the label onto a compact disc is enabled without, on the one hand, damaging the label, and, on the other hand, without the risk of a eccentrical application of the label. Moreover, the risk of tilting the compact disc is reduced because the positioning unit is a fixed compact unit of a centering member and centering rod, whereby the centering member defines a surface, on which the compact disc remains aligned plane-parallel to the label during the whole procedure of labeling, so that the tilting of the compact disc is excluded.

A process for manufacturing a labeling device for compact discs preferably comprises the following process steps:

1. providing a two-part injection mould with a base mould and a top mould forming a hollow mould in a connected and sealed state, whereby the hollow mould corresponds to the form of the labeling device,

2. injection of plastic into the closed injection mould under filling up of the hollow mould with plastic,

3. opening the two-part injection mould and removing the finished labeling device made from plastic.

Due to the construction of the labeling device according to the invention, it is possible to produce the complete labeling device in only one single injection mould process without a finishing being required. During injection of the plastic into the injection mould, the injection inlets can be positioned such that they do not interfere with the outer shape of the labeling device.

Further features and advantages of the present invention will now be explained on the basis of embodiments with respect to the attached drawings.

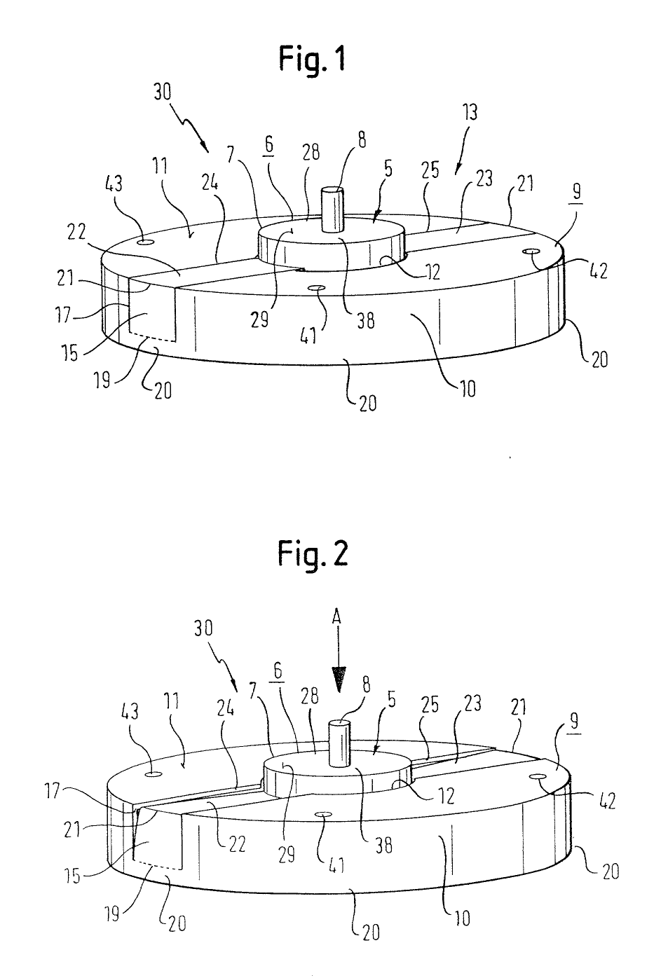

FIG. 1 shows in perspective view a schematic illustration of a first embodiment of the invention in its inoperative position.

FIG. 2 shows in perspective view a schematic illustration of the first embodiment of the invention in a transitional state from the inoperative position into the labeling position.

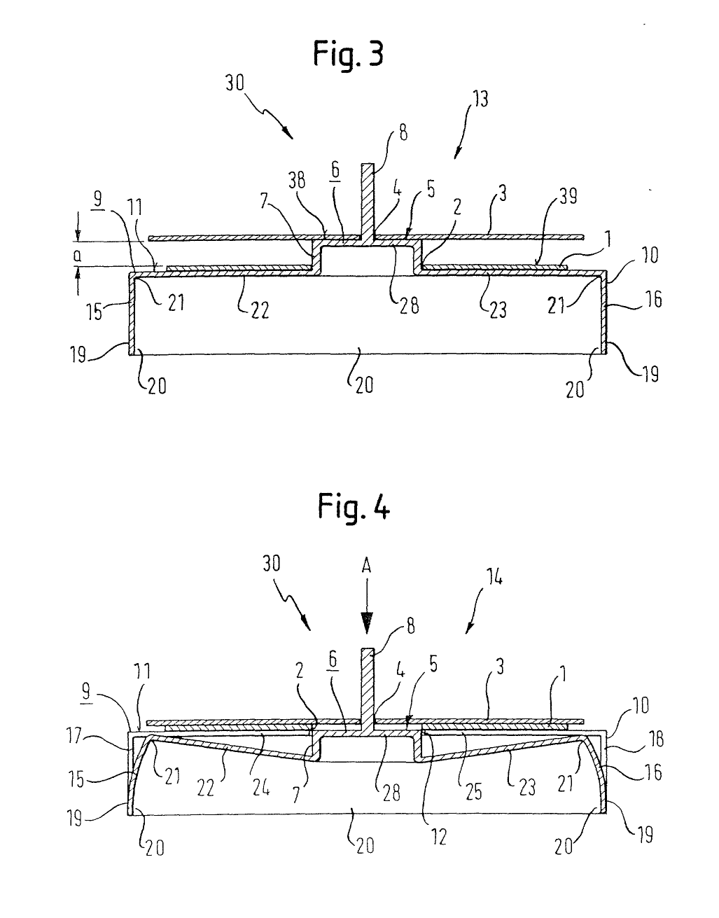

FIG. 3 shows a schematic cross-section of the first embodiment of the invention according to FIG. 1 in inoperative position.

FIG. 4 shows a schematic cross-section of the first embodiment of the invention according to FIG. 1 in the labeling position.

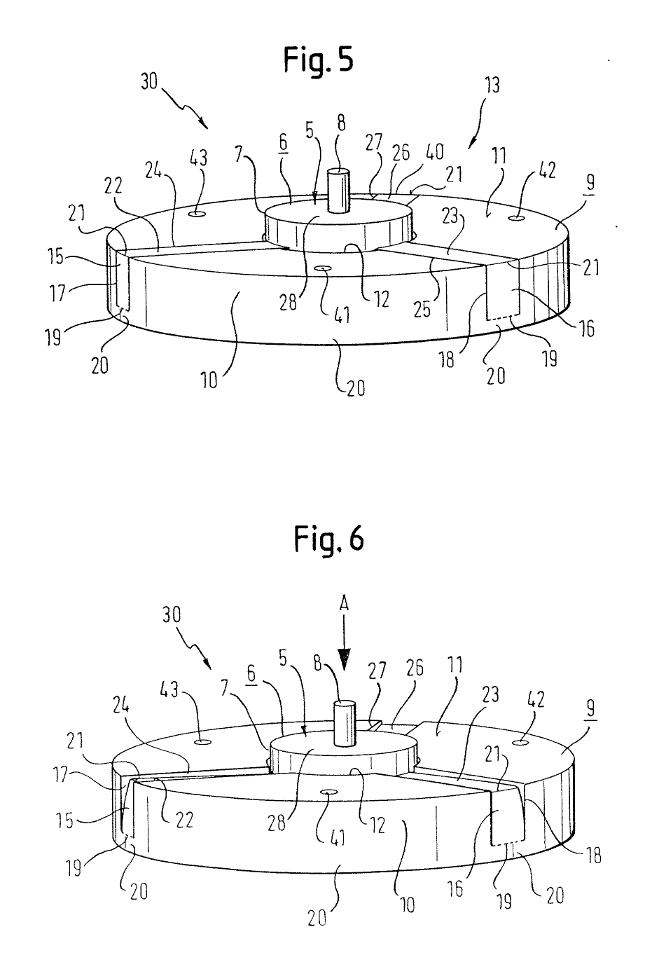

FIG. 5 shows in perspective view a schematic illustration of the second embodiment of the invention in its inoperative position

FIG. 6 shows in perspective view a schematic illustration of the second embodiment of the invention in a transitional state from the inoperative position into the labeling position.

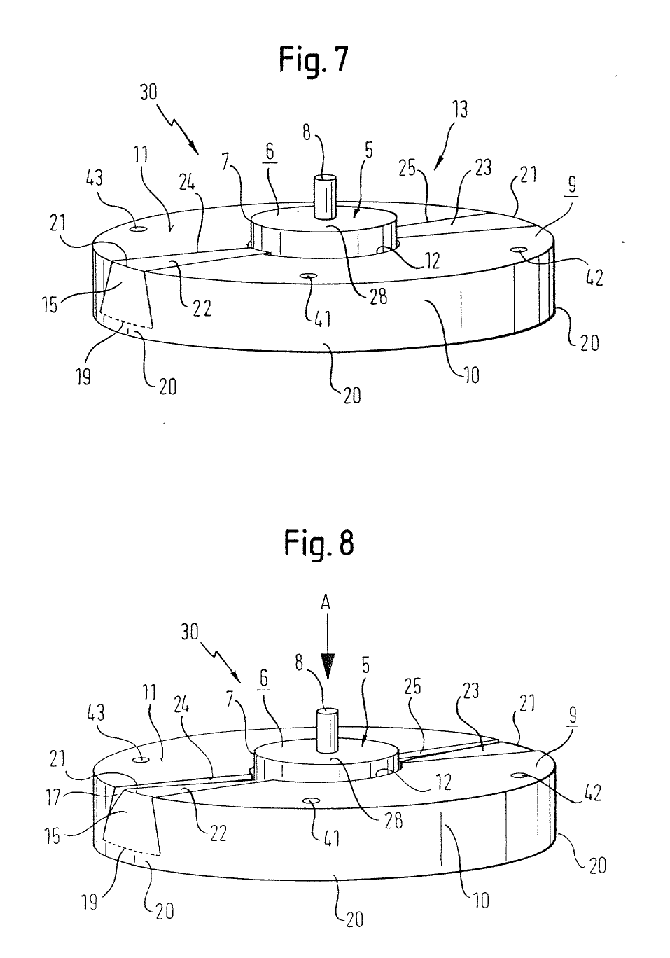

FIG. 7 shows in perspective view of schematic illustration of a third embodiment of the invention in its inoperative position.

FIG. 8 shows in perspective view a schematical illustration of the third embodiment of the invention in a transitional state from the inoperative position into the labeling position.

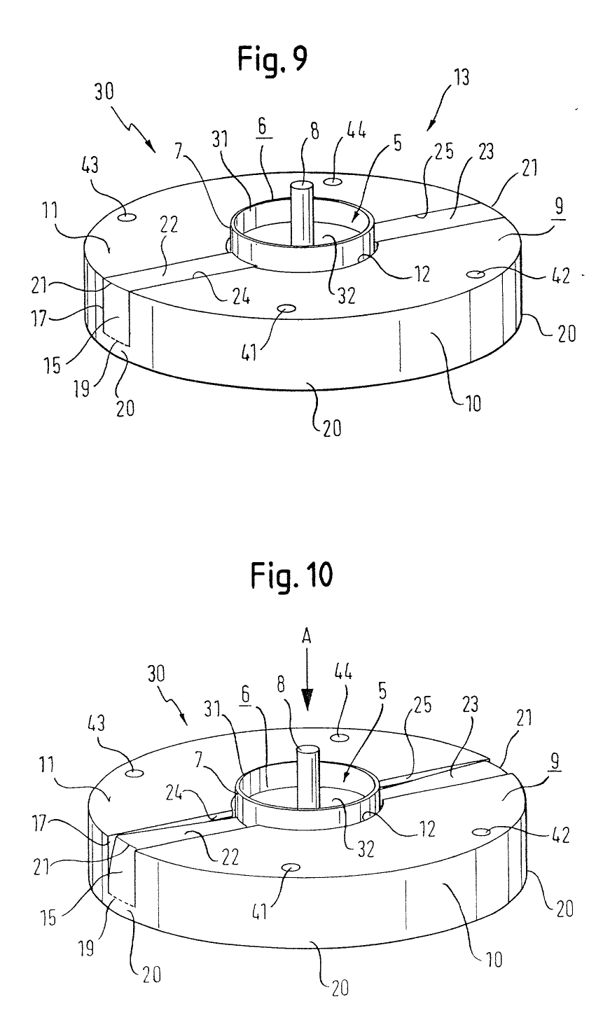

FIG. 9 shows in perspective view a schematic illustration of a fourth embodiment of the invention in its inoperative position.

FIG. 10 shows in perspective view a schematic illustration of a fourth embodiment of the invention in a transitional state from the inoperative position into the labeling position.

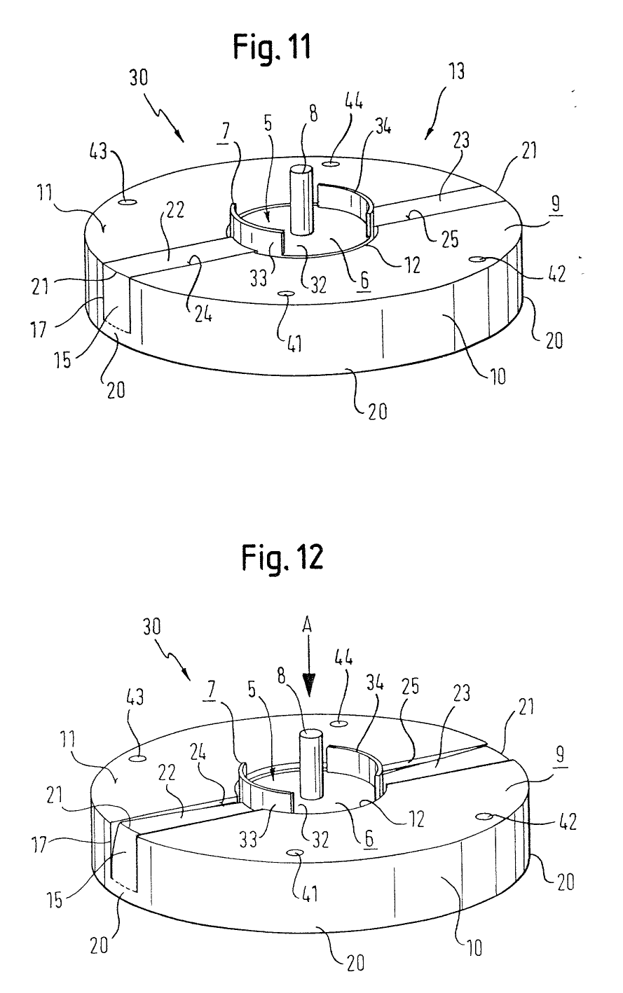

FIG. 11 shows a perspective view of a schematic illustration of a fifth embodiment of the invention in its inoperative position.

FIG. 12 shows a perspective view of a schematic illustration of a fifth embodiment of the invention in a transitional state from the inoperative position into the labeling position.

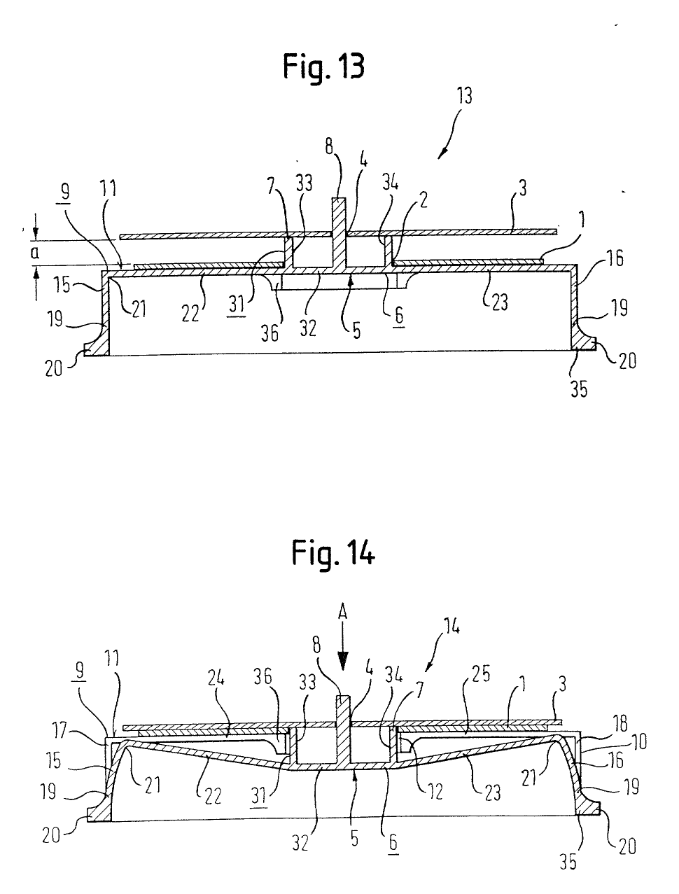

FIG. 13 shows a schematic cross-section through a sixth embodiment of the invention in its inoperative position.

FIG. 14 shows a schematic cross-section of the sixth embodiment of the invention in its labeling position.

FIG. 1 shows in perspective view a schematic illustration of a first embodiment of the invention in its inoperative position. In FIG. 1, reference numeral 5 indicates a positioning member, reference numeral 7 a centering member and reference numeral 8 a centering part in form of a centering rod, whereby centering members and centering rod form a one-piece unit with the positioning member.

Reference numeral 9 indicates a base member on which the label can be placed with non-adhesive side pointing downwards whereby the base member has an outer ring 9 with a disc-shaped top surface 10. There are two flexible tongues incorporated into the outer ring from which the flexible tongue 15 can be seen in perspective view of FIG. 1. The flexible tongue 15 has a flexible tongue root 19 and a flexible tongue tip 21. The flexible tongue is formed integrally with the material of the outer ring 10, and is arranged in a groove 17 of the outer ring, and can be made by simple cutting the outer ring, or during injection molding by subdividing the outer ring into an outer ring section and a flexible tongue section. The flexible tongues are connected through flexible supporting beams 22 and 23 to the positioning member 5. Thereby, the positioning member 5 is practically suspended at the tongue tips of the flexible tongues through the supporting beams 22 and 23. The disc-shaped top surface of the outer ring, therefore, is subdivided into a fixed part, being able to receive a compact disc, whereby the disc-shaped top surface has a central opening, in which the positioning member is arranged, and grooves 24 and 25 within which the supporting beams are accommodated. In this first embodiment of the invention, the positioning member has a base-shaped centering member 7, whereby the base ends in the flat plate 38 in the center of which the centering rod 8 is arranged. On the flat plate, therefore, the compact disc can be placed centrally with respect to the ring-shaped base which in turn can align the label.

For the purpose of labeling, first, the label is placed on the base member with its non-adhesive side pointing downwards, and subsequently the compact disc is placed centrally with its labeling surface pointing downwards over the centering rod 8 on the flat plate 38 on the base surface 29 of the ring-shaped base 28.

FIG. 2 shows in perspective view a schematic illustration of the first embodiment of the invention in a transitional state from the inoperative position into the labeling position. The components which fulfill the same functions as in FIG. 1, are indicated with the same reference numerals, and, therefore will not be explained again. For the transition from the inoperative position into the labeling position, the positioning member 5 is pushed in the direction of the arrow A into the central opening 12 of the disc-shaped top surface 9 of the outer ring 10. Thereby, the tips of the flexible tongues 15 and 16 at the outer ring 10 are pushed inwardly and are biased. Because of the flexible tongues themselves having a concave cross section due to the diameter of the outer ring, for the transition from the inoperative position into the labeling position, the pressure point has to be overcome. This pressure point, at the same time, ensures that a lowering of the positioning member 5 in vertical direction cannot result unintendedly during mounting and centering of the label and the compact disc, respectively. In fact, the placing of the label onto the disc-shaped top surface 9 of the outer ring 10 is not critical first, because usually the labels have a lamination sheet on their adhesive side. However, already during detachment of the lamination sheet from the label resting on the disc-shaped top surface, the risk of an unintended pushing down of the positioning member exists so that the label will be displaced, flexibly raised, and therefore, will no longer be centered and will not be resting with an even surface on the disc-shaped top surface 11 of the outer ring. This risk will be prevented by the present device because of the flexible tongues 15 being arranged at the outer ring 10 having a pressure point due to their concave cross-sections, which require an intended pushing down in direction A of the arrow of the positioning member 5 to effect the labeling process. The further advantage of this device having the concave-curved flexible tongues at the outer ring is, that after labeling has been carried out, the positioning member 5 snaps back into a stable inoperative position. The outer circumference of the massive ring-shaped base 28 and of the centering rod 8 arranged on the base provide for any displacement of the label and the compact disc being arranged centrally on top of each other to be prevented during transition from the inoperative position into the labeling position. Therefore, the present device facilitates the handling during labeling of compact discs and ensures that the user can produce a labeled compact disc without any balance errors during manual labeling.

FIG. 3 shows a schematic cross-section of the first embodiment of the invention according to FIG. 1 in inoperative position. Components having the same function as in FIGS. 1 and 2 will be indicated by the same reference numerals and will not be explained again. Reference numeral 1 indicates a label with a central opening 2 in the label whereby the label is arranged with its adhesive upper side 39 upwards onto the disc-shaped top surface 9 of the outer ring 10. Reference numeral 3 indicates a compact disc with the central opening 4 in the compact disc through which the centering rod 8 of the positioning member 5 projects. The centering rod 8 can have a slightly tapered cross section in longitudinal direction whereby the inclination of the taper is between 0.5 and 5 degrees. Such a taper facilitates the positioning of the compact disc 3 with its central opening 4 on a centering member 7 which, in its first embodiment, is formed base-shaped, and has a flat plate 38 for supporting the compact disc so that the compact disc 3 is held in a distance a from the adhesive surface 39 of the label 1. The distance a corresponds to the height of the ring-shaped base with which the latter projects beyond the disc-shaped top surface 11 of the outer ring 10. Due to the characteristics for the pressure point of. the flexible tongues 15 and 16, the label 1 as well as the compact disc 3 can be mounted reliably with the aid of the positioning member 5 in the inoperative position of the device.

FIG. 4 shows a schematic cross-section of the first embodiment of the invention according to FIG. 1 in labeling position 14. For this, in direction of arrow A, a pressure is applied onto the positioning member with the centrally arranged compact disc 3 so that the positioning member is pushed, suspended at the supporting beams 22 and 23, into the central opening 12 of the disk-shaped top surface 11 of the outer ring 10. Thereby, a pressure point of the flexible tongues 15 and 16 is overcome, and the tips of the flexible tongues 21 bend radially inwardly towards the positioning member because they are connected via the flexible supporting beams 22 and 23 to the positioning member 5. The geometrical dimensions of the positioning member 5 are maintained during this process so that the external diameter of the ring-shaped base and the external diameter of the centering rod 8 are not changed. As soon as the pushing of the compact disc 3 onto the label 1 into the labeling position is completed, and the positioning member is relieved, the positioning member which is suspended at the supporting beams 22 and 23 bounces, due to the effect of the flexible tongues 15 and 16 of the outer ring 10. For this, the flexible tongues 15 and 16 are anchored fixedly with their tongue roots 19 and the base section 20 of the outer ring 10. This fixed anchoring can be achieved by a one-piece manufacturing of the outer ring with flexible tongues.

After pressing the compact disc 3 onto the adhesive side 39 of the label 1, the positioning member 5 can be relieved, and bounces by the elastic force of the flexible tongues 15 and 16 back into the inoperative position so that the labeled compact disc 3 can be removed without any problems from the labeling device due to the taper of the centering rod.

FIG. 5 shows in perspective view a schematic illustration of a second embodiment of the invention in its inoperative position. Components in FIG. 5 having the same. functions as in the preceding figures, are indicated with same reference numerals, and are not explained further. The second embodiment of the invention shown in FIG. 5, differs from the first embodiment of the invention in that instead of two flexible tongues opposite to each other on the outer ring 10 of the base member, now there are three flexible tongues 15, 16 and 40 arranged uniformly at the circumference of the outer ring 10. The second embodiment has the advantage that the positioning member 5 has a three-point suspension due to the three supporting beams 22, 23 and 26 and, therefore, the guidance of the positioning member remains stable during the transition from the inoperative position 13 into the labeling position.

FIG. 6 shows in perspective view a schematic illustration of the second embodiment of the invention in a transitional state from the inoperative position into the labeling position. For this, in arrow direction A, a pressure is applied onto positioning member 5 whereby the tips of the flexible tongues 21 bounce radially inwardly after their pressure point has been overcome. At the same time, the positioning member submerges with its positioning ring-shaped base 28 in the central opening 12 on the top surface 11 of the base member 9. In case the positioning member 5 is relieved, it bounces back into its inoperative position.

FIG. 7 shows in perspective view a schematic illustration of a third embodiment of the invention in its inoperative position. Components of FIG. 7 having the same functions as in FIGS. 1 to 6 are indicated with the same reference numerals and a repeated explanation is omitted. The third embodiment differs from the first two embodiments of the invention in that the flexible tongues 15 and 16 are broader at the roots of the flexible tongue 19 than at the tips of the flexible tongue 21. With this, it is achieved that the flexible tongue, at its tip of its flexible tongue 21 has a lower restoring force than the root of the flexible tongue 19. With this, the flexible tongue becomes softer, however, the pressure point is maintained substantially so that a reliable mounting of the label and compact disc will become possible in the inoperative position, and the positioning member 5 can be pushed into the central. opening 12 of the top surface 12 of the base member 9 with a light pressure onto a centering rod 8.

Moreover, FIG. 7 shows that the supporting beams 22 and 23 are tapered radially inwardly. Due to this taper, the flexibility of the supporting beams 21 and 23 is increased so that the back pressure on the centering member during transition from the inoperative position into the labeling position is reduced by this measure. Further, deformational forces onto the centering member 5 by the supporting beams 22 and 23 will be reduced due to this taper extending radially inwardly.

FIG. 8 shows in perspective view an illustration of the third embodiment of the invention in a transitional state from the inoperative position into the labeling position. Same components of FIG. 8 as they are shown in FIGS. 1 to 7, are indicated with the same reference numerals and an explanation is omitted.

In FIG. 8, a pushing pressure in arrow direction A is applied on the positioning member, and by this, the compact disc arranged on the positioning member is pushed downwards. At the same time of pushing down the positioning member 5, the flexible elements 15 and 16 are deflected radially inwardly at their tips of the flexible tongues, and fixed to the tapered supporting beams 22 and 23, their centering member 5 is lowered in a guided manner to opening 12. The restoring force of the flexible tongues on the outer ring 20 is not weakened by the broader construction of the flexible tongue root so that upon relieving the centering member 5, the latter bounces back into the inoperative position.

FIG. 9 shows in perspective view an illustration of the fourth embodiment of the invention in its inoperative position. Components of FIG. 9 having the same function as in the preceding Figs. are indicated by the same reference numerals. An explanation of these components will be omitted in the following.

The difference between the fourth embodiment of the invention with respect to the. preceding embodiment of the invention mainly is that the positioning member has, instead of a centering base or ring-shaped base, only a centering ring 31. This centering ring stands on a base plate 32 which is connected to the supporting beams 22 and 23 whereby the positioning member is connected with the tips 21 of the flexible tongues 15 and 16, and is kept in inoperative position 13. For labeling a compact disc, a label is placed with its non-adhesive side downwards on the base member 9, and thereby, is centered by means of the centering ring 31 opposite to the center of the centering rod 8. The compact disc can be placed on the centering ring 31 plane-parallel to the label, whereby the width of the ring defines the distance between compact disc and label in the inoperative position 13. During lowering of the centering rod 8 with a positioning member 5, the compact disc will be lowered onto the label, and is glued to the label.

FIG. 10 shows in perspective view a schematic illustration of the fourth embodiment of the invention in a transitional state from the inoperative position into the labeling position. Because the positioning member is lowered into the central opening of base member 9 in arrow direction A, a placing of the compact disc on the adhesive side of the label results. Due to the resilient force of the flexible tongues 15 and 16 on the outer ring 10 the labeled compact disc is raised into the inoperative position subsequent to gluing the label on the compact disc, and can be removed from the labeling device.

FIG. 11 shows a perspective view of a schematic illustration of a fifth embodiment of the invention in a inoperative position. Components of FIG. 11 having the same functions as in the following Fig.s are indicated by the same reference numerals, and an explanation of the latter is omitted. The difference between the fifth embodiment to the preceding embodiments can be found therein that the centering ring is not realized completely but rather only centering segments in form of ring segments 33 and 34 are arranged on the base plate 32 of the positioning member 5. These ring segments are totally sufficient to keep a compact disc in a distance to the label, further, the fifth embodiment of the invention according to FIG. 11 has a centering rod 8 in the center of the base plate which centers the compact disc relatively to the label.

FIG. 12 shows in perspective view a schematic illustration of the fifth embodiment of the invention in a transitional state from the inoperative position into the labeling position. Thereby, the positioning member 5 of the labeling device 30 is lowered into the central opening of the base member 9 in arrow direction A so that the compact disc resting on the ring segments is pushed onto the label being arranged on the base element. Due to the flexible tongues 15 and 16 at the tongue tips 21 of which supporting beams are suspended, supporting the positioning member 5, the positioning member 5 bounces back into the inoperative position as soon as no force in arrow direction A is applied onto the positioning member.

FIG. 13 shows a schematic cross section through a sixth embodiment of the invention in its inoperative position. Same components of FIG. 13 fulfilling same functions as in the preceding embodiments are indicated with the same reference numerals, and an explanation is omitted. In the cross sectional view of FIG. 13, compact disc 3 as well as the label 1 are shown in their inoperative position whereby they are aligned plane parallel with respect to each other and maintain a distance a therebetween, which is determined by the height of the centering ring 31. Instead of a closed centering ring, also ring segments 33 and 34 could be provided, and could generate the same effect, namely that compact disc 3 is centered with its central opening 4 on the label 1 with its central opening 2. The sixth embodiment differs from the embodiments of the preceding Figs. by an enforced base section of the outer ring 10, and by an enforcement in the region of the central opening of the disc-shaped top surface 11 of the outer ring 10. This reinforcement of the edge of the central opening 12 serves for the stabilization of the disc-shaped top surface of the base member 9 so that it is ensured in an advantageous manner that while lowering the positioning member 5, the compact disc can be applied centrally on the label 1.

FIG. 14 shows a schematic cross section of the sixth embodiment of the invention in its labeling position. Components of FIG. 14 having the same functions as in the preceding Fig.s are indicated by the same reference numerals and will not be explained further. In the sixth embodiment, the shape and planarity of the top surface 11 of the base member 9 is improved by reinforcement 36, and by the reinforcement 35 of the base section 20, the stability of the device will be improved as well as its resistance against formation fissures and the region of the flexible tongues 15 and 16 is increased. Besides the reinforcement and radial direction as well as well as in the base sections 20 of the outer ring 10 as well as of the region of the central opening 12 of the base member 9, also rips can be provided extending radially from the outer ring to the central opening 12. There is a further possibility that, prior to applying the label, a compensation disc is placed on the base member 9, and is only then, the label is applied. Such a compensation disc comprises the same central opening as the label, and is centered by the positioning member 5, and serves for the purpose that the grooves 24 and 25 are bridged on the top surface 11 of the base member 9.

The features of the preferred embodiments described above can be combined. The term “compact disc”, used in the above description includes all disc-shaped data carriers, as e.g. DVD and CD-ROM.

1. Device for placing a label (1) with a first central opening (2) onto a compact disc (3) with a second central opening (4), the device comprising: a positioning member (5) having at least one centering member (7), the external diameter of which is adapted to the first central opening (2) of the label (1), and which has a centering part (8) in its center, the external diameter of which is adapted to the second central opening (4) of the compact disc (3), and which projects beyond the centering member (7), a base member (9) with an outer ring (10) carrying a disc-shaped top surface (11), on which the label (1) can be positioned, whereby the top surface (11) has a central opening (12) within which the positioning member (5) is positioned moveably perpendicular to the top surface (11), and, in an inoperative position (13) projects beyond the top surface (11), and is lowered into the central opening (12) in a labeling position (14),
characterized in that
the outer ring (10) has at least one flexible tongue (15, 16) in a first adapted groove (17, 18) of the outer ring (10), the tongue roots (19) of which are fixed to a base section (20) of the outer ring (10), and the tongue tip (21) of which supports a flexible supporting beam (22, 23) whereby the supporting beam (22, 23) extends from the tongue tip (21) radially inwardly into a second adapted groove (24, 25) of the top surface (11) up to the positioning member (5).

2. Device according to claim 1 characterized in that the cross section of the flexible tongues (15, 16) are concave-curved, and each flexible tongue (15, 16) has a pressure point.

3. Device according to claim 1 or claim 2, characterized in that the positioning member (5) is a one-piece unit (6) with a centering member (7) and a centering part (8).

4. Device according to one of the preceding claims, characterized in that the centering member (7) and the centering part (8) are moveable together perpendicular to the top surface (11).

5. Device according to one of the preceding claims, characterized in that the centering member (7), the centering part (8), the flexible supporting beam (22, 23, 26), the flexible tongue (15, 16), and the outer ring (10) are connected to each other none-releasably.

6. Device to one of the preceding claims, characterized in that the device (30) is of one piece.

7. Device according to one of the preceding claims, characterized in that the device (30) is a single injection-molded part.

8. Device according to one of the preceding claims, characterized in that the centering member (7) has a ring-shaped base (28) as centering member, on the top surface (29) of which the centering part (8) projects in the center.

9. Device according to one of the preceding claims, characterized in that the centering member (7) is a ring (31) having a base plate (32) in the center of which a centering part (8) is arranged.

10. Device according to one of the preceding claims, characterized in that the distance between compact disc (3) and label (1) corresponds to the height of the centering member (7) according to which the centering member (7) projects beyond the top surface (11) of the outer ring (10).

11. Device according to one of the preceding claims, characterized in that the centering member (7) has at least two ring segments (33, 34) which project beyond the top surface (11) of the outer ring (10), and are connected to each other by a circular base plate (32).

12. Device according to one of the preceding claims, characterized in that the supporting beam (22, 23, 26) is tapered radially inwardly towards the positioning member (5).

13. Device according to one of the preceding claims, characterized in that the flexible tongue (15, 16) is broader at the tongue root section (19) than at the tongue tip section (21).

14. Device according to one of the preceding claims, characterized in that the outer ring (10) is reinforced at the base section (20).

15. Device according to one of the preceding claims, characterized in that the outer ring (10) has an outer flange (34) at the base section (20).

16. Device according to one of the preceding claims, characterized in that a reinforcement (36) is positioned at the base side in the edge section of the central opening (12) of the top surface (11).

17. Device according to one of the preceding claims, characterized in that at least three flexible tongues (15, 16) with three flexible supporting beams (22, 23, 26) are arranged over the circumference of the outer ring (10).

18. Method for the use of the device according to claims 1 to 17 for labeling a compact disc (3), having the following process steps:
placing the label (1) with the non-adhesive side downwards on the horizontal disc-shaped top surface (11) of the base member (9) whereby the adhesive side of the label (1) points upwards, and the label (1) is pushed with its central opening (2) over the centering member (7),
detaching a lamination sheet from the adhesive side of the label (1),
placing the compact disc (3) with its labeling side downwards onto the positioning member (5) whereby the compact disc (3) is pushed with its central opening (4) over the centering part (8), and is resting on the centering member (7), and whereby the distance between label (1) and compact disc (3) is determined by the height according to which the centering member (7) projects beyond the disc-shaped top surface (11) in the inoperative position (13),
pushing down the positioning member (5) with the compact disc (3) placed on the centering member (7) from the inoperative position (13) in vertical direction into the labeling position (19) on the adhesive side of the label (1),
relieving the positioning member (5) whereby the positioning member (5) bounces back through the flexible tongues (15, 16) at the outer ring (10) into the inoperative position (13) and, thereby raising the labeled compact disc (3) from the top surface (11) of the base member (9) resting on the centering member (7).

19. Method for manufacturing a labeling device according to one of claims 1 to 17 for a compact disc (3), comprising the following process steps:
providing a two-part injection mould with a base mould and a top mould together forming a hollow mould in an assembled and sealed state, whereby the hollow mould corresponds to the shape of the labeling device (30) according to one of claims 1 to 17,
injecting plastic into the closed injection mould under filling up the hollow mould with plastic,
opening the two-part injection mould and removing the labeling device (30) made from plastic.
